(19) United States
(12) Patent Application Publication
(10) Pub. No.: US 2019/0090024 A1
(43) Pub. Date: Mar. 21, 2019

(54) ELASTIC VIDEO BROWSER

(71) Applicant: Eric DuFosse, Flower Mound, TX (US)

(72) Inventor: Eric DuFosse, Flower Mound, TX (US)

(21) Appl. No.: 16/116,712

(22) Filed: Aug. 29, 2018

Related U.S. Application Data
(60) Provisional application No. 62/551,399, filed on Aug. 29, 2017.

(51) Int. Cl. H04N 21/472; H04N 21/4728; G06F 16/9535

(52) U.S. Cl. CPC H04N 21/47217; G06F 16/9535; H04N 21/4728; H04N 21/47205

(57) ABSTRACT

A method, system, and non-transitory computer-readable medium enables browsing of video content. The method includes displaying a plural video player windows for a video sequence associated with the video content. The method further includes controlling browsing through the plural video player windows based on a speed of a navigation controller, wherein a fast speed of the navigation controller triggers a large-time-interval-based browsing of successive video player windows in the plural video player windows, and wherein a slow speed of the navigation controller triggers a small-time-interval-based browsing of successive video player windows in the plural video player windows.

### CROSS-REFERENCE TO RELATED APPLICATIONS

The present application claims the benefit under 35 U.S.C. § 119(e) of the following patent application, which is also hereby incorporated by reference in its entirety for all purposes: U.S. Provisional Patent Application Ser. No. 62/551,399 for New Generation Video Browser, filed Aug. 29, 2017.

### INTRODUCTION

The present invention generally relates to the field of media content browsing, and more particularly relates to a method and a system for browsing and searching of a video content in a video sequence.

Currently numerous media applications exist for viewing, browsing and editing of media content. Such media applications include a number of video applications, media players, TV applications, video editing programs the like. These media applications provide for navigating within media content, such as a video clip, for viewing or editing purposes. For example, a user may use a video application to navigate to a specific part of the video clip to trim a video sequence. For this, the user may need to cue a specific image in the video sequence by manually trying to find the image to be trimmed. This may further require that the user replays the entire video sequence again and again or to try and locate a point in the video sequence where the last video viewing session was aborted. This may be done for a pre-recorded video or a live video feed which is still being recorded. Such a process may be too time-consuming and prone to error due to dependency on manual speed of browsing through the video sequence.

### SUMMARY

In light of the deficiencies discussed above, there is a need to find efficient and robust solutions for browsing and searching for video content in a video sequence, such as for the purpose of editing, analysis and viewing.

In an example embodiment, a method for enabling browsing of video content is provided. The method comprises displaying a plural video player windows for a video sequence associated with the video content. The method further comprises controlling browsing through the plural video player windows based on a speed of a navigation controller, wherein a fast speed of the navigation controller triggers a large time interval based browsing of successive video player windows in the plural video player windows, and wherein a slow speed of the navigation controller triggers a small time interval based browsing of successive video player windows in the plural video player windows.

In some example embodiments, a system for browsing of video content is provided. The system comprises at least one navigation controller, at least one display component, and at least one memory configured to store computer program code. The system further comprises at least one processor configured to execute the computer program code to: control the display component to display a plural video player windows for a video sequence associated with the video content; and control browsing through the plural video player windows based on a speed of the navigation controller, wherein a fast speed of the navigation controller triggers a large time interval based browsing of successive video player windows in the plural video player windows, and wherein a slow speed of the navigation controller triggers a small time interval based browsing of successive video player windows in the plural video player windows.

In some example embodiments, a non-transitory computer-readable medium having stored thereon, computer-executable instructions which when executed by a computer, cause the computer to carry out operations for browsing through a video content may be provided. The operations comprising: displaying a plural video player windows for a video sequence associated with the video content; and controlling browsing through the plural video player windows based on a speed of a navigation controller, wherein a fast speed of the navigation controller triggers a large time interval based browsing of successive video player windows in the plural video player windows, and wherein a slow speed of the navigation controller triggers a small time interval based browsing of successive video player windows in the plural video player windows.

### BRIEF DESCRIPTION OF THE DRAWINGS

Having thus described example embodiments of the invention in general terms, reference will now be made to the accompanying drawings, which are not necessarily drawn to scale, and wherein:

FIGS. 1A-1C illustrate exemplary prior art systems for video browsing and editing;

FIG. 2 illustrates a block diagram of a system for enabling video browsing, in accordance with an example embodiment;

FIG. 3 illustrates a flow diagram of a method for enabling video browsing, according to an example embodiment;

FIG. 4 illustrates an exemplary diagram illustrating the method for enabling video browsing, according to an example embodiment;

FIGS. 5A and 5B illustrate exemplary layouts for the system for video browsing, according to an example embodiment;

FIG. 6 illustrates an exemplary diagram illustrating the method for enabling video browsing, according to an example embodiment;

FIG. 7 illustrates another exemplary diagram illustrating the method for enabling video browsing, according to an example embodiment;

FIG. 8 further illustrates an exemplary diagram illustrating the method for enabling video browsing, according to an example embodiment; and

FIG. 9 also illustrates an exemplary diagram illustrating the method for enabling video browsing, according to an example embodiment.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference, numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

The present invention relates to a media browser application. The media may include such as audio content, video content, multimedia content, an interactive content, a podcast, a broadcast content, an audio/video recording and the like. The media browser application may be configured to enable one or more of browsing, viewing, editing, navigating, searching, trimming, arranging and manipulating video content. There are currently numerous media browsing applications known in the art which allow video browsing and editing. The media browsing applications known in the art may have different layouts or user interfaces for enabling video browsing and editing.

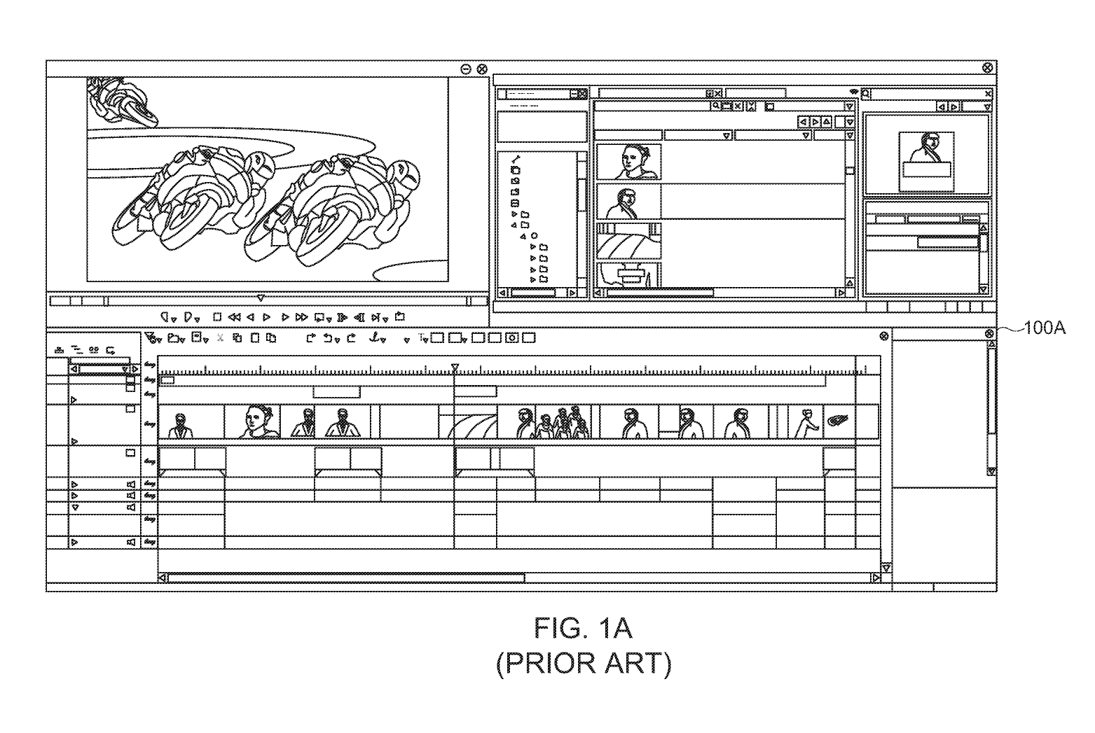

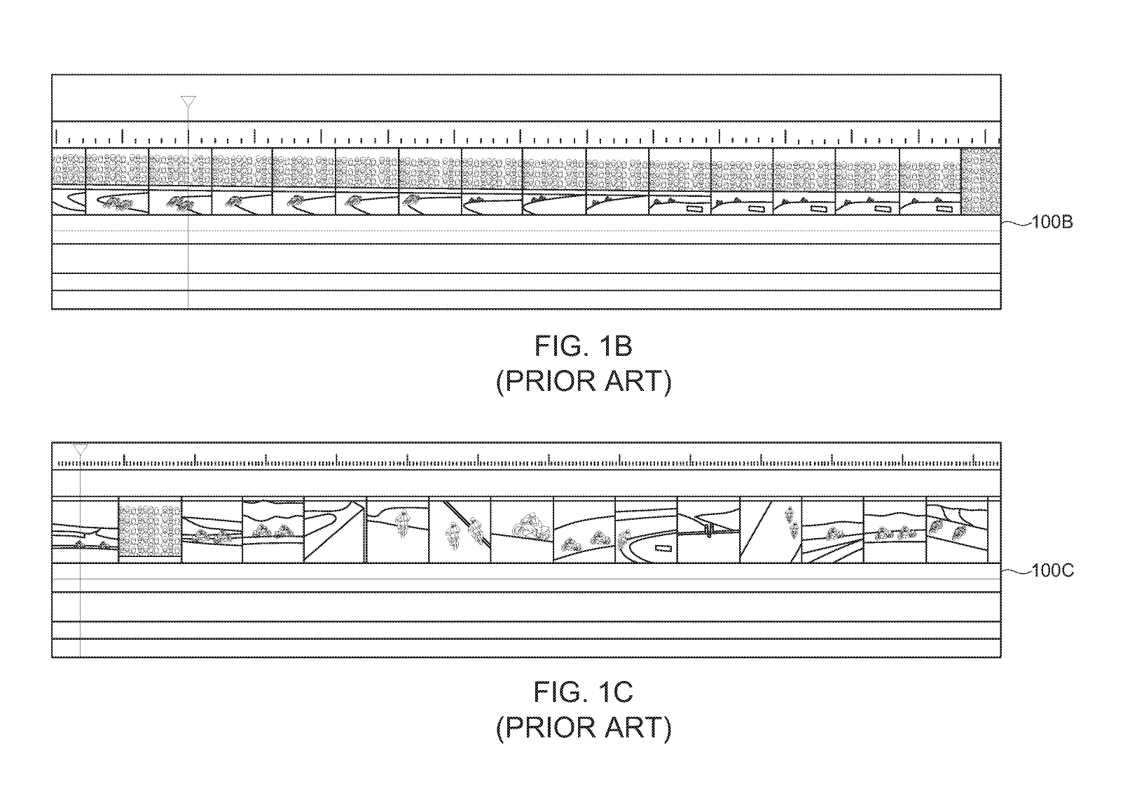

FIGS. 1A-1C illustrate exemplary prior art systems for video browsing and editing. The prior art system of FIG. 1A illustrates an exemplary video editing application interface comprising a plural windows for viewing video content, such that details of the video content in thumbnail format may be viewed in a separate part of the application. The system of FIG. 1A also includes a portion of the interface for showing a timeline view of the video content. A user can manually navigate to any portion of the interface in FIG. 1A using an input mechanism, such as a mouse, a keyboard or any pointing device and access the video content. But this navigation is prone to errors due to largely manual intervention in locating a part of the video content. The interface of FIG. 1A may also include a simple window using a fast forward button, a rewind button or a sliding cursor at the bottom of the screen. However, the navigation of the video content in the FIG. 1A is still a tedious and inaccurate method that requires multiple back and forth actions to get to the desired picture.

FIG. 1B illustrates another exemplary interface of a video editing application in which pluralities of video frames of the video content are shown in a timeline view. The timeline view shows frames that are very closely spaced in time. The user of the video editing application can manually select any frame from the timeline view using the input mechanisms described above. FIG. 1C illustrates another exemplary interface of a video editing application which a plural video frames of the video content are again shown in a timeline view, but the frames are now spaced far in time.

The timeline interfaces depicted in FIG. 1B-1C represent a succession of picture icons aligned in chronologic order. The pictures icons are extracted from the video content by grabbing each video frame or detecting each scene. This exposes a view of a sequence in the user interface and provides an alternative navigation method. This is a popular option for the non-linear editing applications wherein most of the applications have the capability to change the interval between pictures to extend the length of the video clip segment visible on the time line but it is static and requires constant adjustments depending of the content of the video clip and the need to have a global view or focus on a specific segment at a specific step in the editing process.

The prior art systems of FIGS. 1A-1C may illustrate a plural video or TV applications that may enable navigating within the video content for editing the video content. The editing may include such as trimming a particular portion of the video content, cuing a specific image of the video content for replay, or locating the point of a previously aborted viewing session of the video content. This video content may include such as pre-recorded video or a live video feed which is still being recorded. However, all these approaches suffer from limitations discussed above. The methods and systems discussed in the present invention aim to overcome these limitations by enabling video browsing for a video content using a more intuitive and accurate interface.

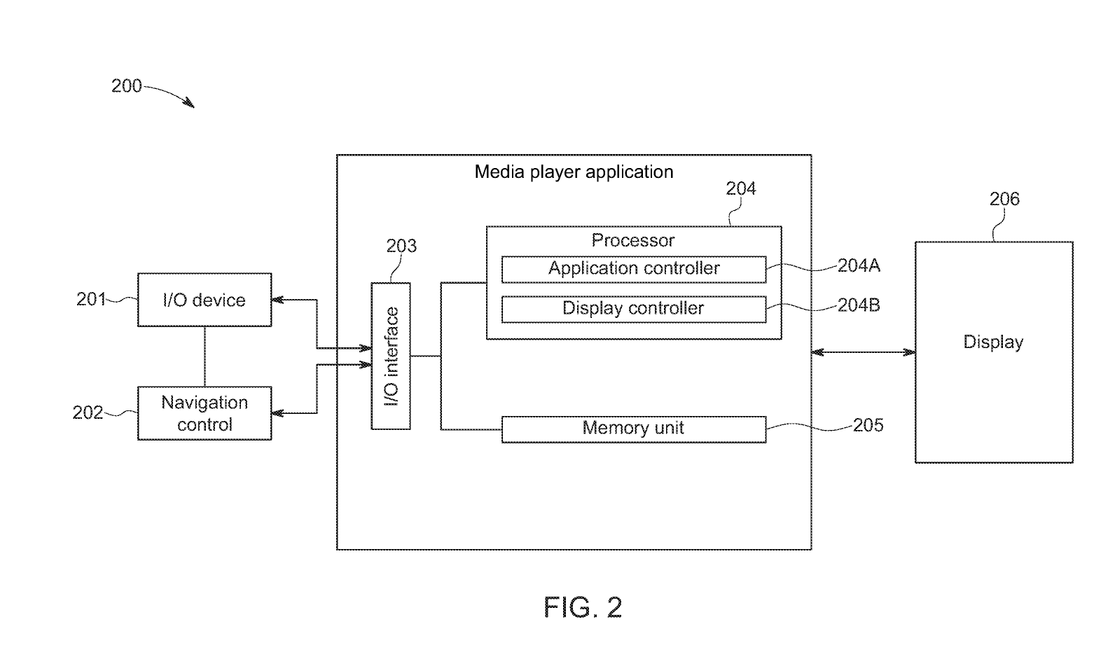

FIG. 2 illustrates a block diagram of a media player application system 200 for enabling video browsing, in accordance with an example embodiment. The media player application system 200 may include an I/O device 201 for accessing the system 200 and a navigation controller 202 for navigating of video content using the media player application system 200. In some example embodiments, the I/O device may include a mouse, a keyboard, a joystick, a pointing device, a keypad, a touchpad, a stylus and the like. The I/O device 201 and the navigation controller may be used to access an I/O interface 203 of the media player application system 200, such as for enabling access of video content for viewing, browsing, searching, editing, trimming, cuing, selecting, zooming and other such manipulation operations.

Still referring to FIG. 2, the media player application system 200 may also include a processor 204 for performing one or more processing operations such as for enabling browsing of video content using the media player application system 200. The processor 204 may in turn include different modules, containing code or control instructions for controlling different functions associated with the video content. The processor 204 may include an application controller 204a for controlling media player application related functions, such as accessing the media player application, translating the I/O operations into suitable instructions for accessing video content, navigating through video content, browsing the video content and the like.

The processor 204 may also include a display controller 204b for controlling display related functions for a display interface 206 of the media player application system 200. Such as displaying a plural windows in different layouts, changing the display based on I/O operations, controlling timing intervals between different video frames and the like. In some example embodiments, the processor 204 The processor 204 may be in communication with a memory unit 205 which may store computer program code or instructions for performing various exemplary functions of the media player application system 200 as disclosed by the methods and systems discussed herein. In some example embodiments, the memory unit 205 may be a non-transitory computer readable medium.

The memory unit 205 may include a static random access memory, dynamic random access memory, read-only memory, cache or Flash memory, a hard disk, a CD/DVD and the like. The memory unit 205 may be configured to store instructions such as to implement a method for enabling video browsing for the media player application system 200.

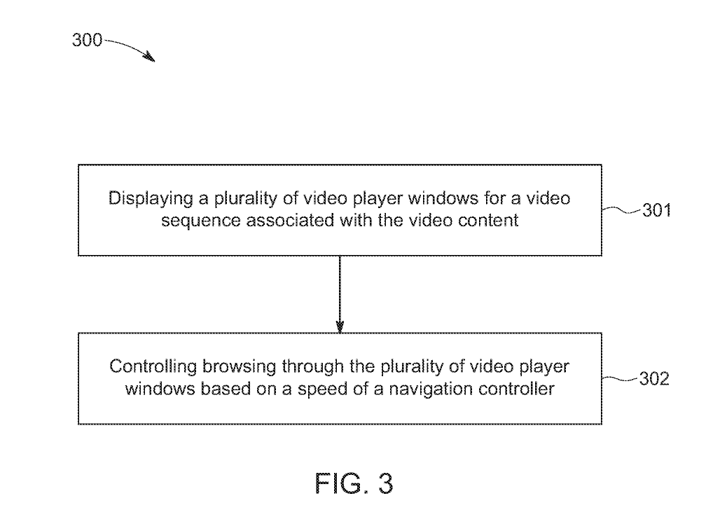

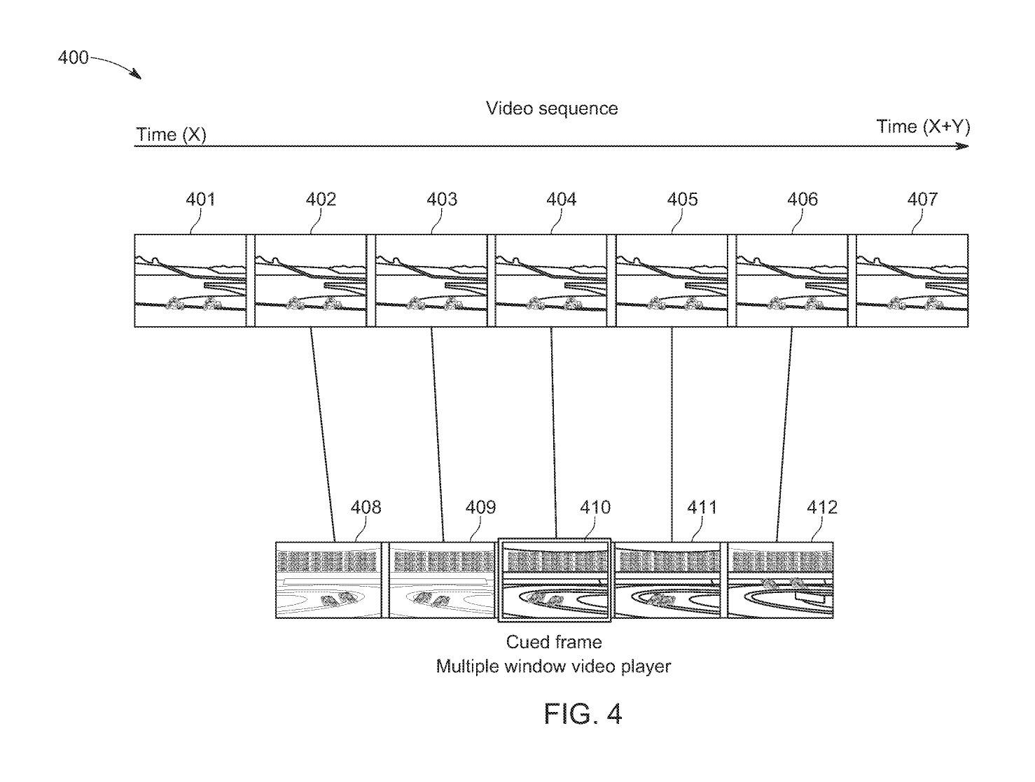

FIG. 3 illustrates a flow diagram of a method 300 for enabling video browsing, according to an example embodiment. The method 300 may include, at 301, displaying a plural video player windows for a video sequence associated with the video content. For example, FIG. 4 illustrates a video sequence 400 including a plural video player windows 401-407 for the video sequence 400 which are varying in time, starting from an instant X in time and till an instant X+Y in time. The successive video player windows, such as 401 and 402, 402 and 403, 403 and 404 and so on are separated by a time interval, which may also be considered a frame interval.

In some example embodiments, using the plural video player windows 401-407 of the video sequence, a multiple window video player may display a subset of the plural video player windows 401-407, the plural video player windows 408-418 using dynamic scaling of time intervals between the plural video player windows 401-407. Such a multiple window video player may enable browsing of video content for facilitating searching, cueing or making of a specific video window or frame. For example, in the video sequence of multiple video windows 408-412, frame 410 may be cued. The cued frame 410 may be a region of interest video window for a user, that is to say, a frame that the user may be searching for. The dynamic scaling of time intervals between the plural video player windows 401-407 may enable the user to search for the region of interest video window from the plural video player windows 408-412 based on the controlling of browsing through video windows in the sequence 400.

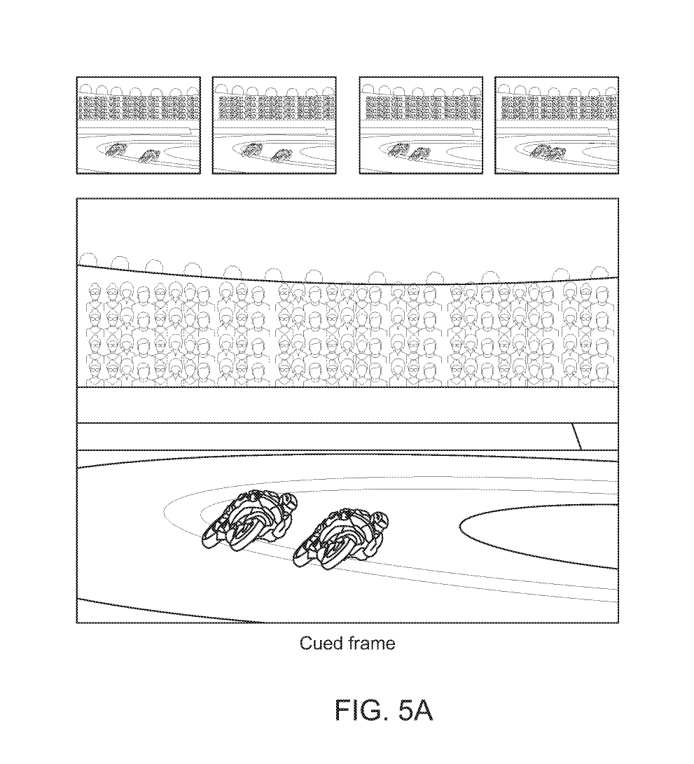

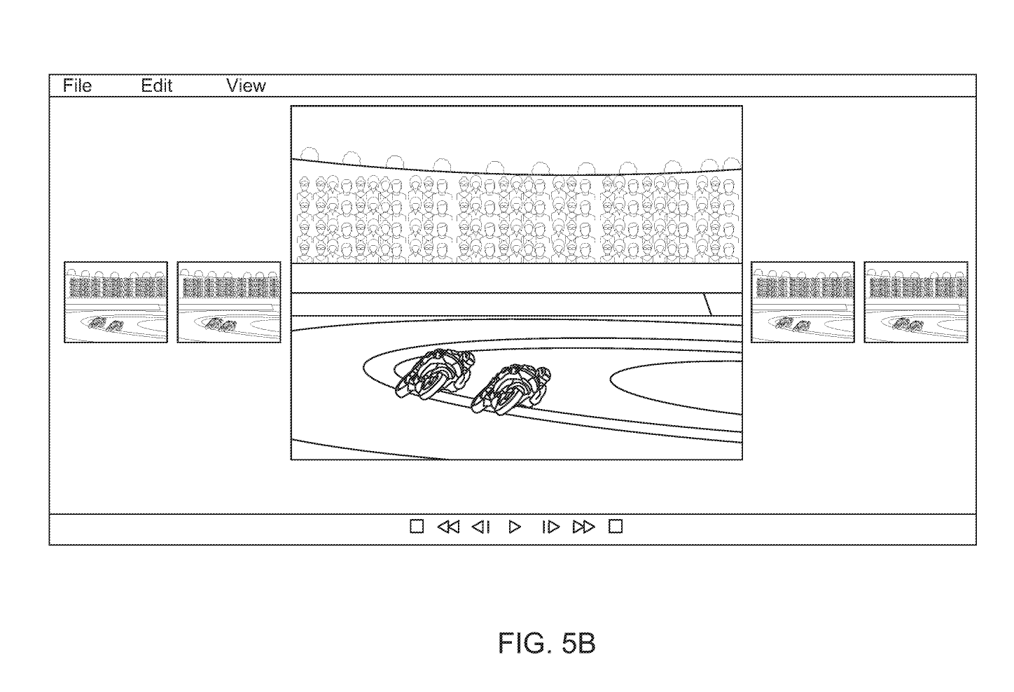

In some example embodiments, the plural video windows 408-412 may be displayed in the multiple window video player using the layouts depicted in FIGS. 5A-5B.

The layout of FIG. 5A illustrates a multiple window video player in which the plural video player windows 408,409, 411, and 412 are arranged in a timeline view in a first display area and the cued frame 410 or the region of interest video window is displayed in a large window in a second display area. In the illustrated example of FIG. 5A, the second display area is below the first display area. In some other embodiments, the first display area and the second display area may be arranged in a different layout.

For example, in the example embodiment of FIG. 5B, the second display area comprising the cued frame 410, is in middle of the first display area. The illustrations in FIGS. 5A-5B are for exemplary purposes only and by no means limit the scope to the invention to the illustrated embodiments only. Many other layouts may also be possible for the multiple window video player, as may be understood by a person of ordinary skill in the art. The different layouts of the multiple window video player may enable browsing the video content based on the method 300 which may include at, step 302, controlling browsing controlling browsing through the plural video player windows based on a speed of a navigation controller.

The navigation controller may be such as a jog controller, a shuttle controller, a play button and the like. The jog controller may include a small wheel on a control surface, which may be used to navigate back and forth within a video clip or a video sequence. The shuttle controller may include a knob to fast forward or rewind at various speeds within the video sequence. When the navigation controller is moved at a fast speed, this may trigger a large time interval based browsing of successive video player windows in the plural video player windows.

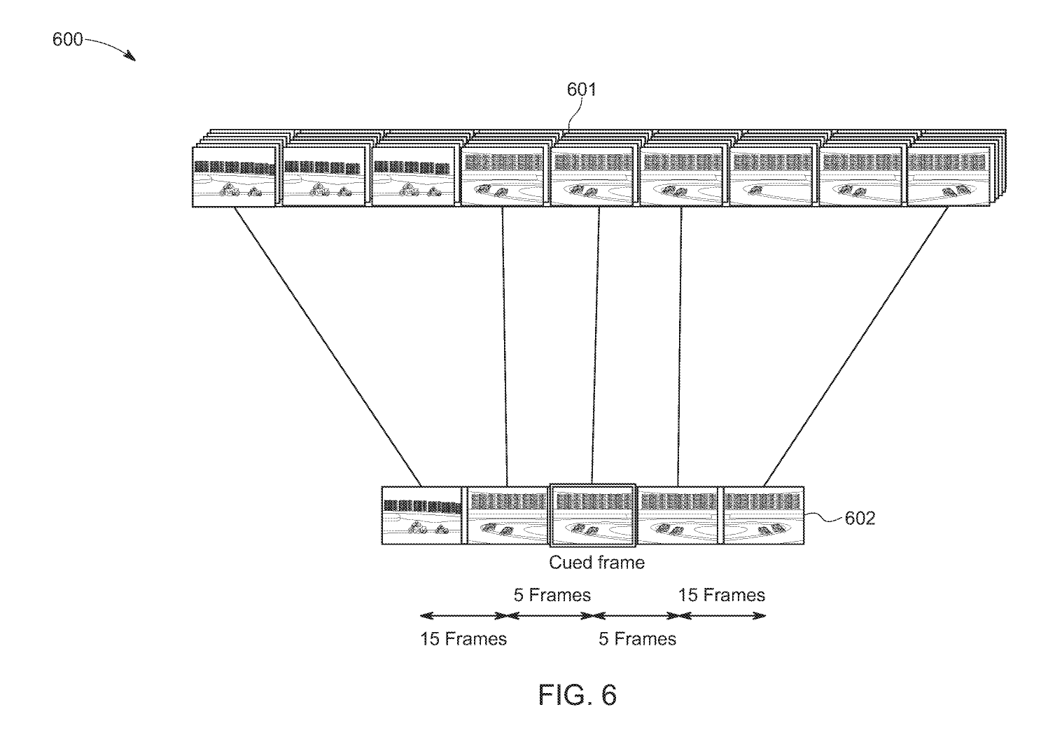

For example, FIG. 6 illustrates a fast navigation controller speed based browsing of video content. In the video sequence 601, groups of five frames are depicted in an extended timeline view. When the navigation controller is moved at a fast speed, from the video sequence 601, initially 15 frames are skipped, then 5 frames are skipped to reach the cued frame and then again 5 frames are skipped, then again 15 frames are skipped. The resulting video player windows are illustrated in the video sequence 602. The skipping of frames is due to dynamic scaling of time intervals between successive video player windows. The fast speed of the navigation controller may be maintained till the region of interest video window or cued frame is located.

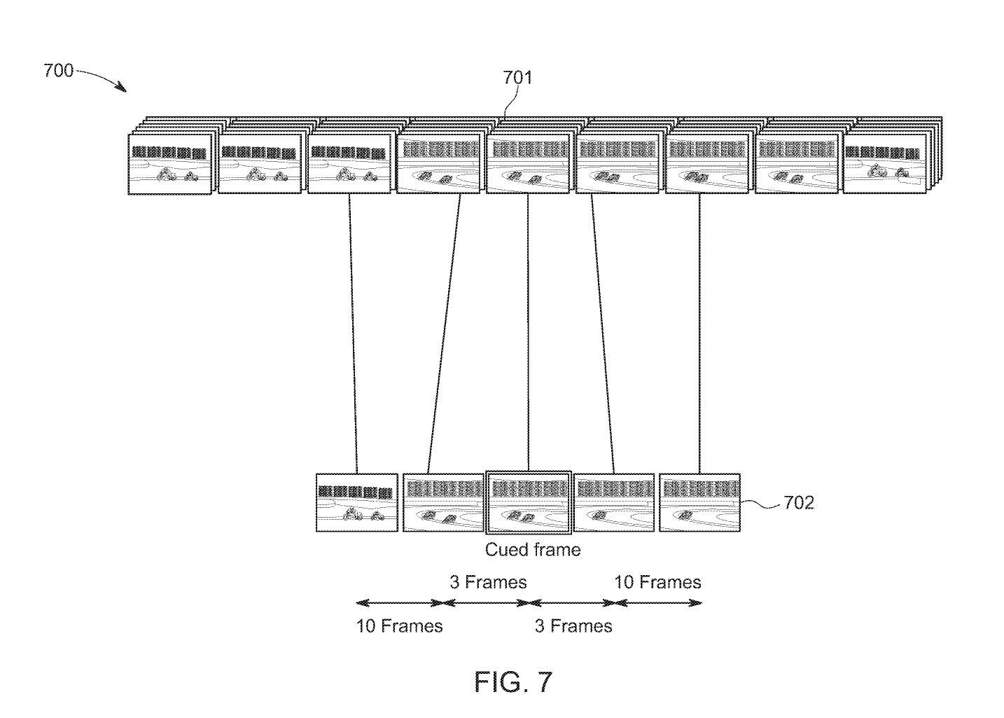

When the region of interest video window is located, the navigation controller may be moved slowly to identify the exact frame. When the navigation controller is moved at a slow speed, this may trigger a small time interval based browsing of successive video player windows in the plural video player windows. For example, FIG. 7 illustrates a slow navigation controller speed based browsing of video content. At lower speeds, the navigation controller will trigger reduced intervals between the successive video windows to improve accuracy but keep a view of an extended segment. For example, at slow speed, from the video sequence 701, initially 10 frames are skipped, then 3 frames are skipped, then again 3 frames are skipped, and then again 10 frames are skipped to give an output video sequence 702.

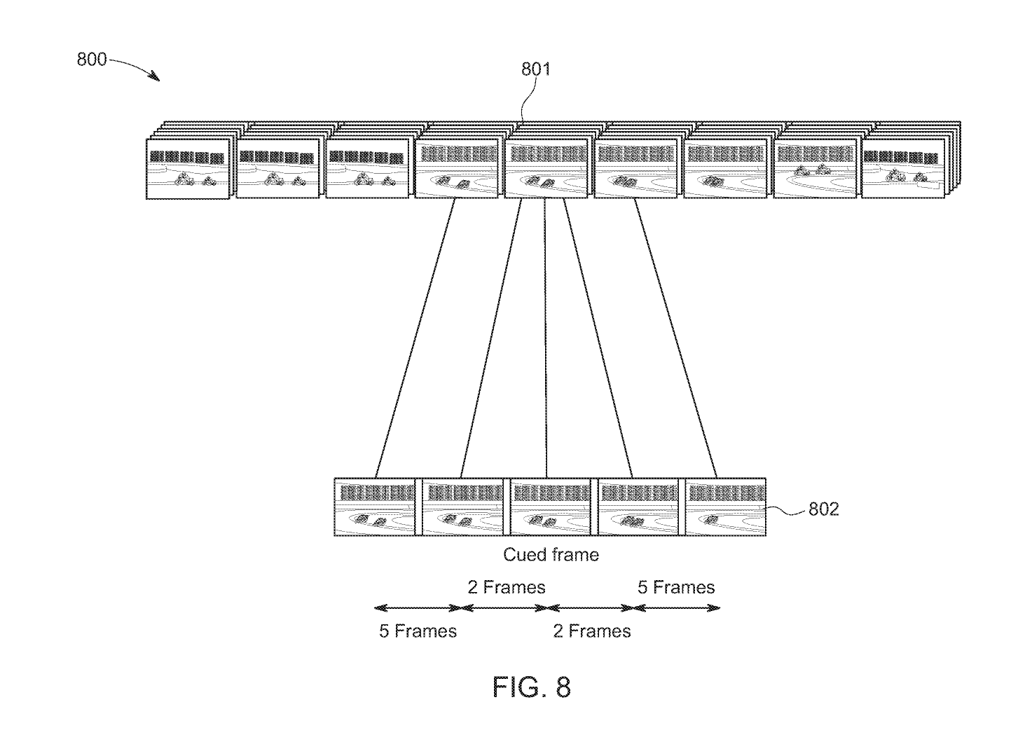

At even lower speed, such as illustrated in FIG. 8, a low speed with limited intervals will allow to select accurately an image for cueing or marking purposes. For example, at even slower speed, from the video sequence 801, initially 5 frames are skipped, then 2 frames are skipped, then again 2 frames are skipped, and then again 5 frames are skipped to give an output video sequence 802.

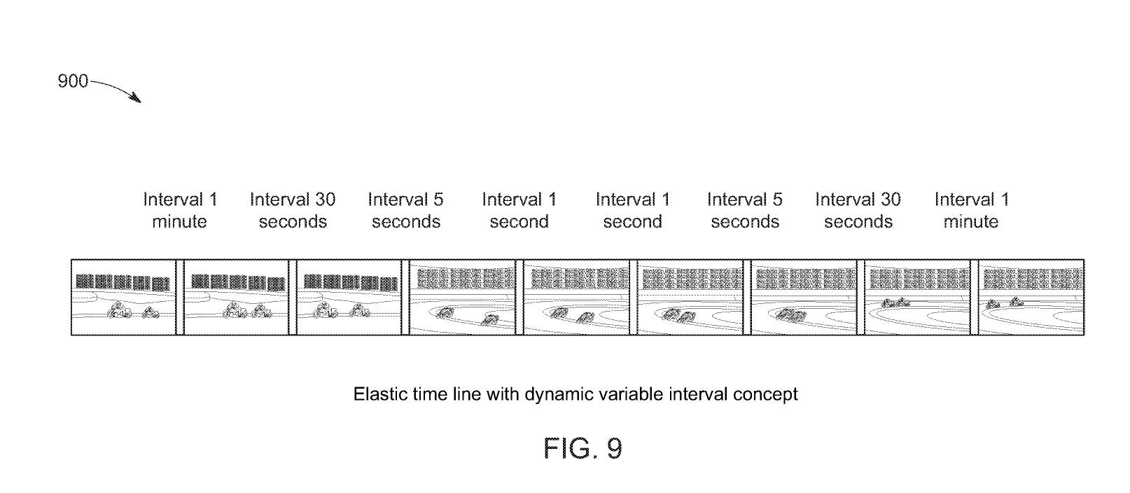

The time interval between the successive video windows can also be varied at any speed depending on the position of each video window related to the center video window. In this case the center window may represent the video position to be cued or marked. For example FIG. 9 illustrates a video sequence 900 in which the center frame is the cued frame or the region of interest video window and the time intervals between successive video player windows are varied, such as 1 minute, 30 seconds, 5 seconds, and 1 second, relative to the center frame.

In some example embodiments, the far left position video window may be used as a point of reference. In other example embodiments, the far right position video window may be used as a point of reference.

In some example embodiments, the media player applications using the method 300 may configure various matrix tables to adjust the interval between the frame at various speed of search/jog the navigation controller and the variation of the time interval for maximum flexibility.

In some example embodiments, the method 300 may further include searching for the video window of interest from the plural video player windows based on the variation of the time interval between the successive video player windows.

In an example embodiment, an apparatus for performing the method 300 of FIG. 3 above may comprise a processor (e.g. the processor 204) configured to perform some or each of the operations of the method of FIG. 3 described previously. The processor 204 may, for example, be configured to perform the operations (301-302) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (301-302) may comprise, for example, the processor 204 which may be implemented in the media player application system 200 and/or a device or circuit for executing instructions or executing an algorithm for processing information as described above.

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

What is claimed:

1. A method for enabling browsing of video content comprising:
displaying plural video player windows for a video sequence associated with the video content; and
controlling browsing through the plural video player windows based on a speed of a navigation controller, wherein a fast speed of the navigation controller triggers a large time interval based browsing of successive video player windows in the plural video player windows, and wherein a slow speed of the navigation controller triggers a small time interval based browsing of successive video player windows in the plural video player windows.

2. The method of claim 1, further comprising enabling searching for a region of interest video window from the plural video player windows based on the controlling of browsing.

3. The method of claim 2, wherein displaying the plural video player windows further comprises:
displaying the plural video player windows in a timeline view in a first display area; and
displaying the region of interest video window in a large window in a second display area, wherein the second display area is below the first display area.

4. The method of claim 2, wherein displaying the plural video player windows further comprises:
displaying the plural video player windows in a timeline view in a first display area; and
displaying the region of interest video window in a large window in a second display area, wherein the second display area in middle of the first display area.

5. The method of claim 1, wherein the navigation controller comprises a jog wheel.

6. The method of claim 1, wherein the navigation controller comprises a shuttle knob.

7. The method of claim 1, wherein controlling browsing through the plural video player windows based on a speed of a navigation controller further comprises varying the time interval between the successive video player windows the based on a position of each video window relative to a center video window.

8. The method of claim 1, wherein controlling browsing through the plural video player windows based on a speed of a navigation controller further comprises varying the time interval between the successive video player windows based on a position of each video window relative to a far left position video window.

9. The method of claim 1, wherein controlling browsing through the plural video player windows based on a speed of a navigation controller further comprises varying the time interval between the successive video player windows based on a position of each video window relative to a far right position video window.

10. A method comprising:
displaying a plural video player windows for a video sequence associated with the video content;
varying a time interval between successive video player windows in the plural video player windows based on a speed of a navigation controller, wherein a fast speed of the navigation controller triggers a large time interval between the successive video player windows, and wherein a slow speed of the navigation controller triggers a small time interval between the successive video player windows; and
enabling searching for a video window of interest from the plural video player windows based on the variation.

11. A system for browsing of video content, the system comprising:
at least one navigation controller;
at least one display component;
at least one memory configured to store computer program code; and
at least one processor configured to execute the computer program code to:
control the display component to display a plural video player windows for a video sequence associated with the video content; and
control browsing through the plural video player windows based on a speed of the navigation controller, wherein a fast speed of the navigation controller triggers a large time interval based browsing of successive video player windows in the plural video player windows, and wherein a slow speed of the navigation controller triggers a small time interval based browsing of successive video player windows in the plural video player windows.

12. The system of claim 11, the processor is further configured to enable searching for a region of interest video window from the plural video player windows based on the control of browsing.

13. The system of claim 12, wherein the processor is further configured to control the display component to:
display the plural video player windows in a timeline view in a first display area; and
display the region of interest video window in a large window in a second display area, wherein the second display area is below the first display area.

14. The system of claim 11, wherein the navigation controller comprises a jog wheel.

15. The system of claim 11, wherein the navigation controller comprises a shuttle knob.

16. The system of claim 11, wherein to control browsing through the plural video player windows based on the speed of the navigation controller the processor is further configured to:
vary the time interval between the successive video player windows the based on a position of each video window relative to a center video window.

17. The system of claim 11, wherein to control browsing through the plural video player windows based on the speed of the navigation controller the processor is further configured to:
vary the time interval between the successive video player windows based on a position of each video window relative to a far left position video window.

18. The system of claim 11, wherein to control browsing through the plural video player windows based on the speed of the navigation controller the processor is further configured to:
vary the time interval between the successive video player windows based on a position of each video window relative to a far right position video window.

19. A non-transitory computer-readable medium having stored thereon, computer-executable instructions which when executed by a computer, cause the computer to carry out operations for browsing through a video content, the operations comprising:
displaying a plural video player windows for a video sequence associated with the video content; and
controlling browsing through the plural video player windows based on a speed of a navigation controller, wherein a fast speed of the navigation controller triggers a large time interval based browsing of successive video player windows in the plural video player windows, and wherein a slow speed of the navigation controller triggers a small time interval based browsing of successive video player windows in the plural video player windows.

20. The non-transitory computer-readable medium of claim 19, wherein the operations further comprising:
enabling searching for a region of interest video window from the plural video player windows based on the controlling of browsing.
